(19) United States
(12) Patent Application Publication
(10) Pub. No.: US 2016/0085947 A1
(43) Pub. Date: Mar. 24, 2016

(54) SHARING MEDIA CONTENT WITH MULTIPLE RECIPIENTS

(71) Applicant: Nokia Technologies Oy, Espoo (FI)

(72) Inventors: Toni STRANDELL, Helsinki (FI); Oleksandr KONONENKO, Helsinki (FI); Janne KAASALAINEN, Espoo (FI); Carlos QUIROZ CASTRO, Helsinki (FI); Timo PAKKALA, Espoo (FI)

(21) Appl. No.: 14/961,301

(22) Filed: Dec. 7, 2015

Related U.S. Application Data
(63) Continuation of application No. 12/255,748, filed on Oct. 22, 2008, now abandoned.

(51) Int. Cl. G06F 21/31; H04N 21/475

(52) U.S. Cl. CPC G06F 21/31; H04N 21/4753

(57) ABSTRACT

A computing device may provide a credential related to a service. Responsive to a validation of the credential, an identification of the service may be added to a contact listing associated with the computing device. Thereafter, a user of the computing device may select the service from the contact listing in order to upload a content object to the service. Similarly, the user of the computing device may select one or more peer devices from the contact listing. Responsive to the peer device selections, the content object may be transmitted to the one or more peer devices.

### FIELD

Aspects of the invention generally relate to computer networking. More specifically, an apparatus, method and system are described that allow sharing of media content with third party services, e.g., using a mobile device or a web interface to share media content with multiple contacts and/or media distribution services.

### BACKGROUND

Improvements in computing technologies have changed the way people accomplish various tasks. For example, some estimates indicate that between the years 1996 and 2007, the fraction of the world's population that uses the Internet grew from approximately 1% to approximately 22%. Irrespective of the actual percentages, trends suggest that the Internet will continue to grow.

Along with the growth of the Internet, users and service providers have developed numerous applications and corresponding interfaces to facilitate the exchange of information. For example, a user of a personal computer (PC) may share a video file with her friend as an electronic mail (e-mail) attachment. Alternatively, the user may upload the video file to a (third-party) service, e.g., YouTube, and the video file may subsequently be downloaded at the friend's computing device.

Given the growth and development of computing technologies, users expect to be able to share information with groups of people. For example, users may share digital pictures of their children with people they are close to (e.g., friends, relatives, etc.). Moreover, users frequently want information to be accessible to a larger base of the viewing population (e.g., to co-workers, acquaintances, and sometimes even strangers). In order to achieve wider distribution, or to use different services for different purposes, a user can upload information (e.g., pictures) to multiple services. Uploading the information to the multiple services, however, requires the user to take prior actions or steps in conjunction with various configuration windows in order to facilitate/enable the upload operations. Accordingly, if the user is a novice, the user will have to endure a learning curve in order to successfully upload the information to each service. Even if the user is experienced, the multiple actions required of the user represent both an annoyance and an expense in terms of time.

### BRIEF SUMMARY

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects in a simplified form as a prelude to the more detailed description provided below.

To overcome limitations in the prior art described above, and to overcome other limitations that will be apparent upon reading and understanding the present specification, aspects of the present disclosure are directed to an apparatus, method and system for uploading selected information to one or more services. More specifically, a user may select one or more services from a list of contacts. A subsequent transmission of the selected information may result in the selected information being uploaded to the one or more services.

Various aspects of the disclosure may provide for transferring a media item directly from a mobile device to a service, or uploading the media item only once to a service and then sending upload commands for the same media item to the service. Other various aspects may relate to transferring the media item from a first service to one or more additional services. Other aspects may include adding the media item to a selected folder, album, channel or the like, or may result in a sharing of the media item with one or more users, groups, and the like.

Various aspects of the disclosure may, alone or in combination with each other, relate to generating a service contact. Other various aspects may relate to receiving a credential associated with a service, transmitting a request to the service for shared information, receiving information from the service responsive to the request; and transmitting contact information based at least in part on the received information.

These and other aspects of the invention generally relate to populating a list of contacts with one or more service contacts. The one or more service contacts may be used to upload information to one or more services. From the perspective of a user, the user may be able to transmit information to other users at substantially the same time that the information is uploaded to one or more services.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the invention.

FIG. 2 illustrates a data processing architecture suitable for carrying out one or more illustrative aspects of the invention.

FIG. 3 illustrates a computing architecture suitable for enabling a service in accordance with one or more aspects of the invention.

FIG. 4 illustrates a method suitable for enabling a service in accordance with one or more aspects of the invention.

FIG. 5 illustrates a computing architecture suitable for sharing media with contacts and channels in accordance with one or more aspects of the invention.

FIG. 6 illustrates a method suitable for sharing media with contacts and channels in accordance with one or more aspects of the invention.

FIG. 7 illustrates a use case scenario suitable for demonstrating one or more aspect of the invention.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

Conventional sharing applications may allow media to be sent to a user account as an email attachment. It may be possible to define which album/channel media is to be uploaded to or to whom it is to be shared. Providing such definition may be cumbersome for a single service, let alone if the media is destined for multiple services, which may require different subject or body fields associated with the corresponding email(s). Other sharing services (such as SHARE ONLINE and SHOZU) enable media upload to selected services, however, the selections are performed in conjunction with one or more settings or configuration menus. For example, SHARE ONLINE allows selecting multiple destinations for a media item, but each destination is selected separately in a multi-view process. Similarly, in SHOZU, one can configure carbon-copied (cc'ed) sites so that an uploaded media item is sent to all selected cc'ed services.

As demonstrated herein, a service may be presented to a user as one or more contacts in a user computer's phonebook or similar application, thereby alleviating the need for a user to engage in cumbersome configuration or setup operations. A user may be able to select one or more services to upload media to while transmitting the media to other contacts at (substantially) the same time.

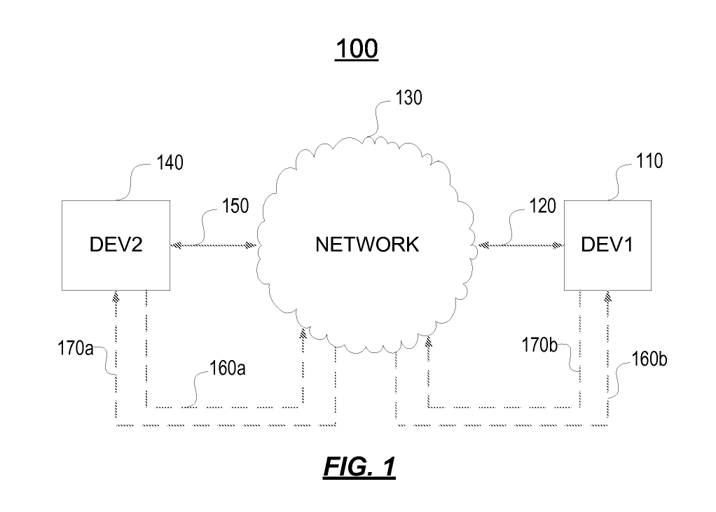

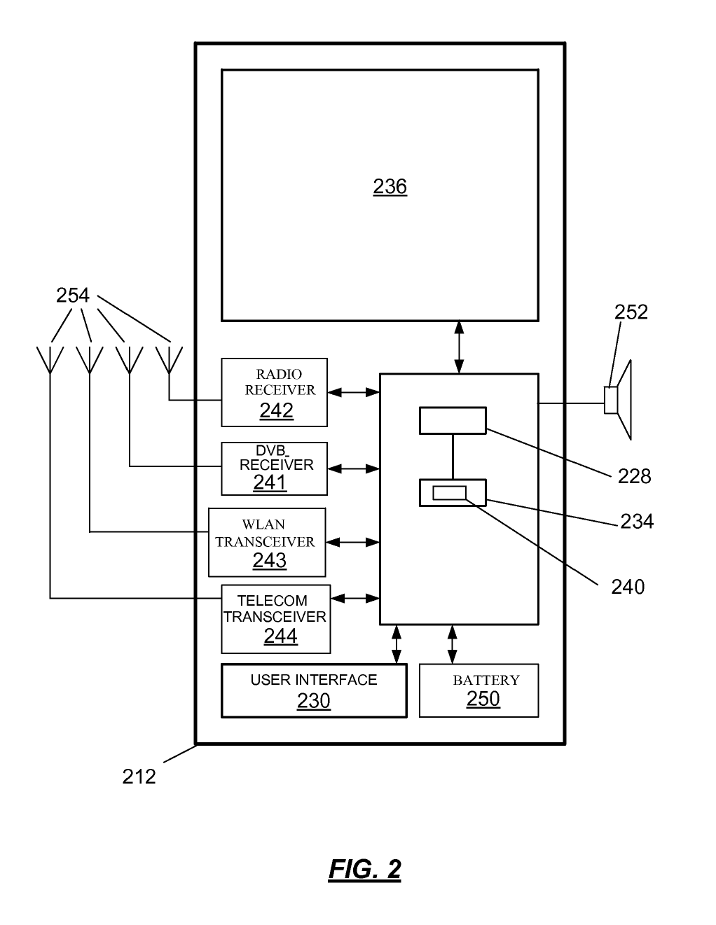

FIG. 1 illustrates a network computing environment 100 suitable for carrying out one or more aspects of the present invention. For example, FIG. 1 illustrates a first device DEV1 110 (e.g., device 212, FIG. 2) connected to a network 130 via a connection 120. Network 130 may include the Internet, an intranet, wired or wireless networks, or any other mechanism suitable for facilitating communication between computing platforms in general. FIG. 1 also depicts a second device DEV2 140 (e.g., a server) connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include images, files, and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, DEV2 140 may exchange communications with a plurality of other devices (not shown) in addition to DEV1 110. The communications may be conducted using one or more communication protocols. Furthermore, computing environment 100 may include one or more intermediary nodes (not shown) that may buffer, store, or route communications between the various devices.

FIG. 2 illustrates a generic computing device 212, e.g., a desktop computer, laptop computer, notebook computer, network server, portable computing device, personal digital assistant, smart phone, mobile telephone, cellular telephone (cell phone), terminal, distributed computing network device, mobile media device, or any other device having the requisite components or abilities to operate as described herein. As shown in FIG. 2, device 212 may include processor 228 connected to user interface 230, memory 234 and/or other storage, and display 236. Device 212 may also include battery 250, speaker 252 and antennas 254. User interface 230 may further include a keypad, touch screen, voice interface, four arrow keys, joy-stick, stylus, data glove, mouse, roller ball, touch screen, or the like. In addition, user interface 230 may include the entirety of or portion of display 236.

Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown).

Furthermore, the computing device 212 may include additional hardware, software and/or firmware to support one or more aspects of the invention as described herein. Device 212 may be configured to receive, decode and process digital broadband broadcast transmissions that are based, for example, on the Digital Video Broadcast (DVB) standard, such as DVB-H, DVB-T or DVB-MHP, through a specific DVB receiver 241. Digital Audio Broadcasting/Digital Multimedia Broadcasting (DAB/DMB) may also be used to convey television, video, radio, and data. The mobile device may also include other types of receivers for digital broadband broadcast transmissions. Additionally, device 212 may also be configured to receive, decode and process transmissions through FM/AM Radio receiver 242, WLAN transceiver 243, and telecommunications transceiver 244. In at least one embodiment of the invention, device 212 may receive radio data stream (RDS) messages.

Device 212 may use computer program product implementations including a series of computer instructions fixed either on a tangible medium, such as a computer readable storage medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, radio, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 234), such as a semiconductor, magnetic, optical, or other memory device, and may be transmitted using any communications technology, such as optical infrared, microwave, or other transmission technology. Such a computer program product may be distributed as a removable storage medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

In at least one embodiment, device 212 may include a mobile client implemented in a C-based, Java-based, Python-based, Flash-based or any other programming language for the Nokia® S60/S40 platform, in Linux for the Nokia® Internet Tablets, such as N800 and N810, in a browser-based markup language, and/or other implementations. Device 212 may communicate with one or more servers over Wi-Fi, GSM, 3G, or other types of wired and/or wireless connections. Mobile and non-mobile operating systems (OS) may be used, such as Windows Mobile®, Palm® OS, Windows Vista® and the like. Other mobile and non-mobile devices and/or operating systems may also be used.

By way of introduction, aspects of the disclosure provide for the population of contact information in a phonebook or other such listing in a user computing device. The contact information may include a reference to a service to allow a user to select the service as an upload destination for a media item. One or more credentials may be validated to ensure that the user is who she claims to be.

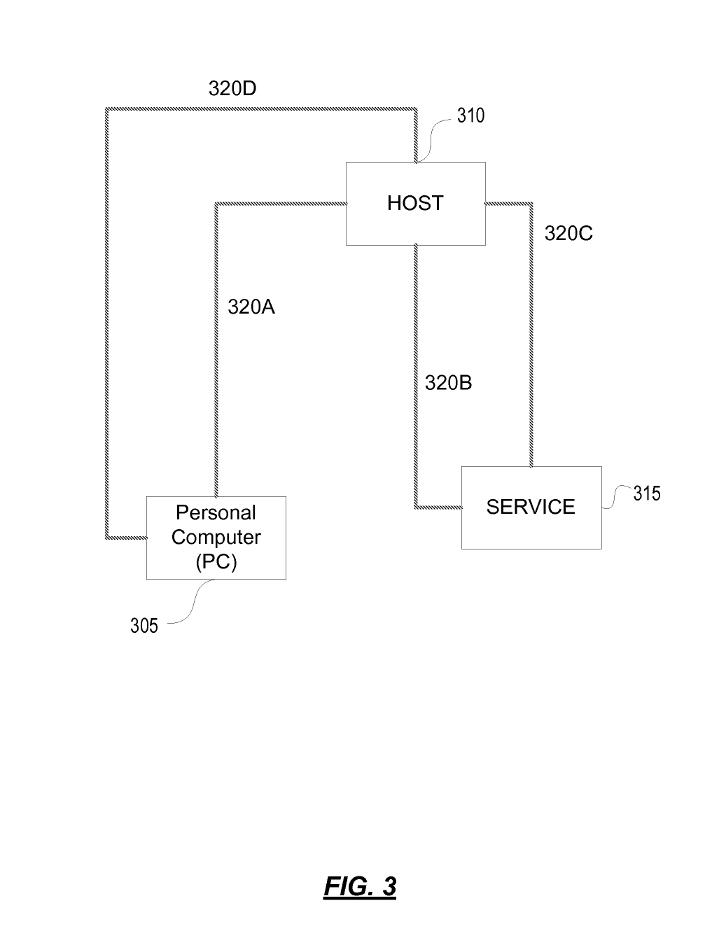

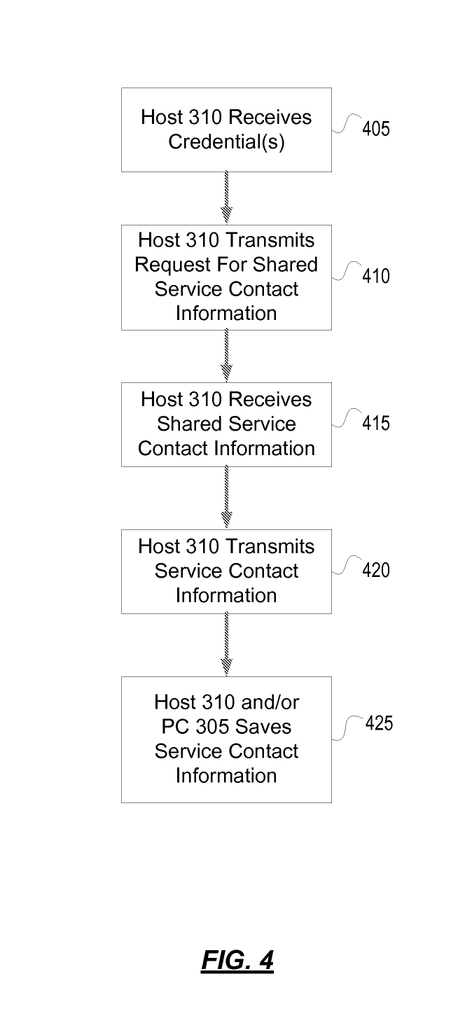

FIG. 3 depicts a computing architecture suitable for carrying out one or more aspects of the invention. As shown in FIG. 3, a personal computer (PC) 305 may communicate (as shown via link 320A) with a host 310. Responsive to communication 320A, host 310 may communicate (as shown via link 320B) with service 315. Responsive to receipt of communication 320B from host 310, service 315 may communicate (as shown by link 320C) with host 310. Responsive to receipt of communication 320C from service 315, host 310 may communicate with PC 305 (as shown by link 320D). Host 310 may act as a proxy server between device 305 and service(s) 315. The nature of communications 320A-D and the interactions between PC 305, host 310, and service 315 will be described more fully below with respect to FIG. 4.

The computer architecture of FIG. 3 is merely illustrative. In some embodiments, substitute computing devices may be used in place of PC 305, host 310, and service 315. For example, a mobile device (e.g., device 212 of FIG. 2) may be used in place of PC 305. Host 310 and service 315 may take the form of one or more computing devices, including PCs, laptops, servers, mobile phones, mobile terminals and the like. Additional devices (not shown) may be included in some embodiments. For example, intermediary servers, routers and the like may facilitate communication between the various computing devices shown in FIG. 3. Moreover, in some embodiments, one or more of the computing devices may be combined into a single device. For example, host 310 and service 315 may be combined into a single form-factor in some embodiments.

FIG. 4 illustrates a method wherein one or more illustrative aspects of the invention may be practiced. In particular, the method of FIG. 4 is described below based on the computer architecture discussed above in relation to FIG. 3. It is understood that the method of FIG. 4 may be adapted to accommodate modifications to the computer architecture of FIG. 3 without departing from the scope and spirit of the instant disclosure.

In step 405, PC 305 may communicate 320A with host 310. Communication 320A may include PC 305 providing host 310 with one or more (user) credentials associated with service 315. As such, in step 405, host 310 may receive the one or more credentials from PC 305 by way of communication 320A. The one or more credentials may include a username, a password, a personal identification number (PIN), a fingerprint or retinal scan, or the like. For example, a username and password for logging into a user account associated with service 315 may be provided to host 310 in accordance with step 405. Alternatively, or additionally, the one or more credentials may include a token, an API key that service 315 provides for the user, or the like.

In step 410, host 310 may communicate 320B with service 315. Communication 320B may include a request for shared service contact information. The request may include a request for relevant information, such as a user's contacts, buddies, albums, channels, and the like. Accordingly, in step 410, host 310 may transmit a request for shared service contact information to service 315, based at least in part on the one or more credentials received in step 405. Host 310 may validate the one or more credentials, or the one or more credentials may be transmitted from host 310 to service 315 for validation at service 315. A connection between host 310 and service 315 may be established based at least in part on one or more application programming interfaces (APIs) or the like, which are published by and/or publicly available from each respective service.

In step 415, service 315 may communicate 320C with host 310. Communication 320C may include shared service contact information, which as described above with respect to step 410, may include relevant information, such as a user's contacts, buddies, albums, channels, and the like. Accordingly, in step 415, host 310 may receive shared service contact information from service 315.

In step 420, host 310 may communicate 320D with PC 305. Communication 320D may include service contact information associated with service 315. Accordingly, in step 420, host 310 may transmit service contact information to PC 305 based at least in part on the shared service contact information received at host 310 in conjunction with step 415. The service contact information may include contact information to enable PC 305 to easily communicate or engage in a transaction with service 315 (potentially by way of host 310). For example, the service contact information may include a world-wide-web (www) address, an email address, an IP address, or any information that may uniquely identify service 315.

In step 425, PC 305 may save the service contact information for subsequent use. Alternatively, in some embodiments the service contact information may be saved at host 310 and may be transmitted from host 310 to PC 305 periodically or when PC 305 demands the service contact information. In those embodiments, steps 425 and 420 may be interchanged to avoid unnecessarily transmitting the service contact information from host 310 to PC 305. Furthermore, in some embodiments, communication 320A between PC 305 and host 310 may include a comparison between service contact information stored at PC 305 and service contact information stored at host 310. Such a comparison may eliminate or reduce the need to communicate duplicate information, or may be used to clarify or eliminate discrepancies. The service contact information may be used to populate a listing of contacts as more fully described below.

The method illustrated in FIG. 4 described PC 305 as providing one or more credentials in step 405 and receiving and saving service contact information in steps 420 and 425. In some embodiments, a first device may provide the one or more credentials and a second device may be the recipient of the service contact information.

In view of the foregoing description, it is understood that a user may populate a listing of contacts with contact information related to one or more services. In particular, a host (e.g., host 310) may serve as a proxy, interfacing a client device (e.g., PC 305) to a service (e.g., service 315) to allow the client device to automatically obtain contact information from the service. A user of the client device may simply identify services to be accessed (e.g., by way of a web address identifying each service) and one or more usernames and passwords or the like, generally referred to herein as credential(s). Thereafter, the identification of the services and the credential(s) may be transmitted (e.g., step 405, communication 320A) from the client device to an intervening computing device (e.g., host 310).

The intervening computing device may validate the credential(s) to ensure that the user of the client device is who she claims to be. Responsive to the validation, the intervening computing device may communicate (e.g., step 415, communication 320C) with the one or more services. The intervening computing device may maintain a mapping of the various inputs or communication protocols required by each service. The intervening computing device then sends back contact information, e.g., in the form of a vcard, which can be saved in the listing of contacts on the client device (e.g., PC 305).

As an illustrative example, a user of a client device may want to upload an image of her baby to two services. The first service may require the image to be uploaded in a Joint Photographic Experts Group (JPEG) format and the second service may require the image to be uploaded in a Graphics Interchange Format (GIF). The image may be stored at the client device in a bitmap (BMP) file format, and the image may be transmitted (e.g., step 405, communication 320A) from the client device to an intervening computing device (e.g., host 310) with an identification of the two services (e.g., as selected from a list of contacts). Thereafter, the intervening computing device may transform/translate the received BMP image to JPEG and GIF formats suitable for uploading the image to the first and second services, respectively. In a similar manner, if the first service is configured to operate via a first communication protocol (e.g., BLUETOOTH), and the second service is configured to operate via a second communication protocol (e.g., Session Initiation Protocol (SIP)), the implementation functionality of the protocols may be located at the intervening computing device, and the intervening computing device may be configured to initiate or arrange the communication with the services using the appropriate protocol(s).

Based on the foregoing example, it is understood that the fabrication of a client device (e.g., PC 305) may be simplified because the client device may communicate with an intervening computing device (e.g., host 310) using a single format (e.g., BMP in the above example), protocol and the like. The intervening computing device may be configured to support communication with multiple services each requiring its own communication protocol or setting/configuration information (e.g., as determined from each service's publicly or privately accessible APIs). Thus, from the perspective of the client device, the client device may treat the differing services as being similar with respect to communication formats, protocols and the like. The client device may simply populate contact information related to the various services in a contact listing, allowing a user to engage the differing services using a common communication protocol or technique; the intervening computing device may provide any translation required to facilitate communication with the various services.

Based on the foregoing description, it is understood that credentials for different services (e.g., service 315) and specific information required to upload media to a service may be stored in host 310. Contact information transferred to PC 305 may include an identifier for the specific service 315 and possibly a location (e.g., an identification of a channel, an album, etc.) that the media should be uploaded or shared to. The contact information may be embodied as metadata or the like and may be hidden from a user's view. For each contact (which may include information related to an identification of a channel, album, etc.) in service 315, a separate contact entry may be created in host 310 (and/or PC 305). Responsive to a selection of shared targets for the media, PC 305 may select a set of one or more contact entries. Host 310 may use a service identification in each contact entry to select the correct credentials and APIs to use, and use the credentials and the contact, album, channel, etc. associated with the contact information to upload the media to the service (e.g., service 315) and appropriate albums, channels, etc.

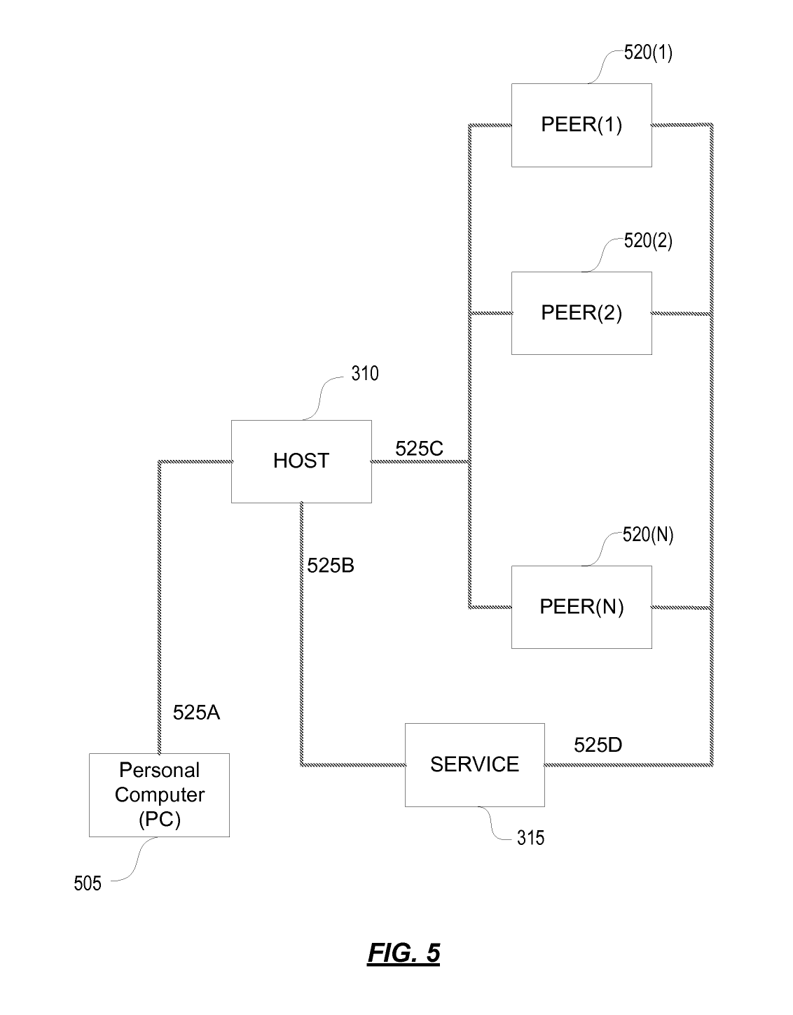

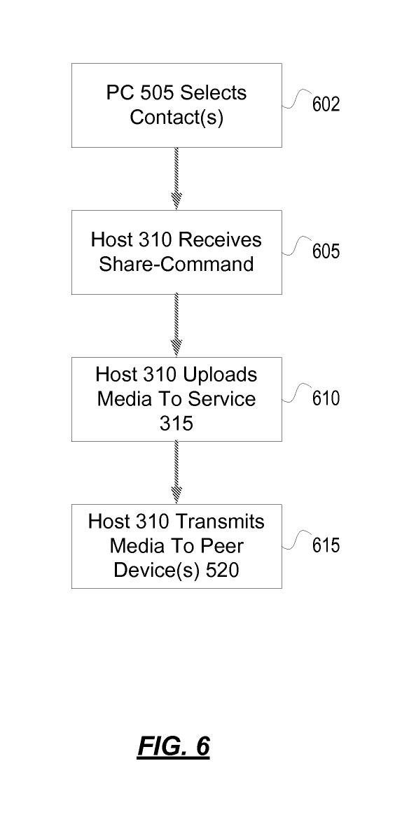

FIG. 5 depicts a computing architecture suitable for carrying out one or more aspects of the invention. As shown in FIG. 5, a PC 505 may communicate (as shown via link 525A) with host 310. In some embodiments, PC 505 may be the same PC 305 (or more generally, computing device) as shown in FIG. 3 and may be configured to operate as described above in conjunction with the method illustrated in FIG. 4. Alternatively, PC 505 may be a different computer or data processing device, e.g., another device owned or operated by the same user of PC 305. Responsive to communication 525A, host 310 may communicate (as shown via link 525B) with service 315. Responsive to communication 525A, host 310 also may communicate (as shown via link 525C) with a number (N) of peer devices 520(1)-520(N). A peer device 520 may represent any device suitable for engaging in a sharing operation of uploaded media, or more specifically, may represent an intended direct or indirect target or recipient of shared media. A peer device may also represent any device with which PC 305 and/or host 310 can communicate, either directly or indirectly, via one or more communication links and/or media. Responsive to communication 525B, service 315 may communicate (as shown via link 525D) with peer devices 520(1)-520(N). The nature of communications 525A-D and the interactions between PC 505, host 310, service 315, and peer devices 520(1)-520(N) will be described more fully below with respect to FIG. 6.

It is understood that the computer architecture of FIG. 5 is merely illustrative, and that additional computing devices may be used, or substitute computing devices may be used in place of PC 505, host 310, service 315, and peer devices 520(1)-520(N), as described above with respect to FIG. 3.

FIG. 6 illustrates a method wherein one or more illustrative aspects of the invention may be practiced. In particular, the method of FIG. 6 is described below based on the computer architecture discussed above in relation to FIG. 5. It is understood that the method of FIG. 6 may be adapted to accommodate modifications to the computer architecture of FIG. 5 without departing from the scope and spirit of the instant disclosure.

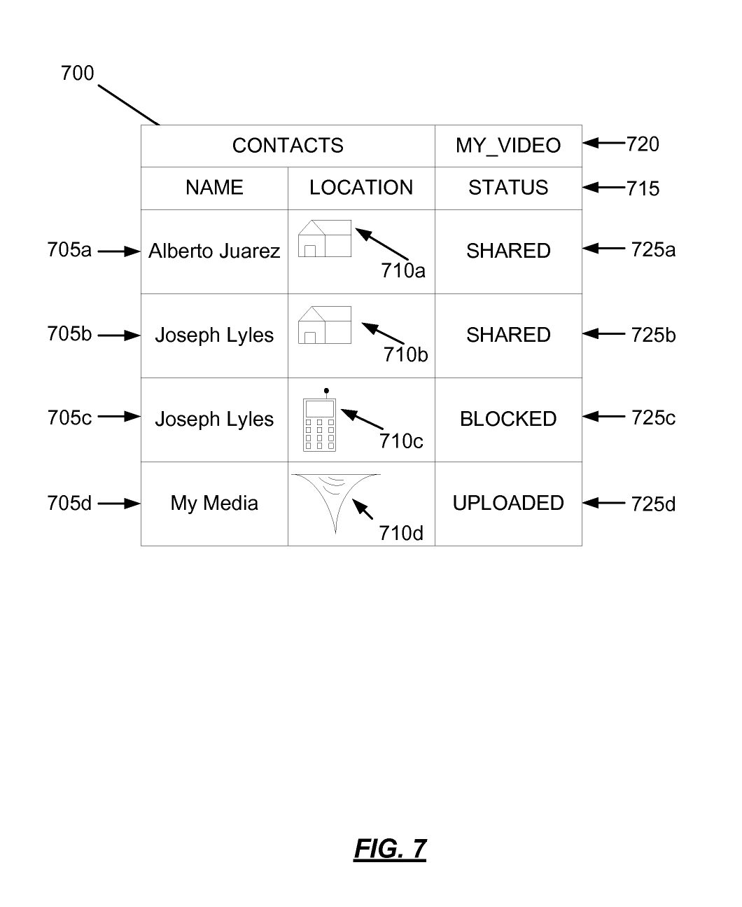

In step 602, (a user of) PC 505 may select one or more contacts to share media with. The selection may be based at least in part on the contact information described above in conjunction with steps 420 and 425 of FIG. 4. The mechanics of performing the selection may be conducted in accordance with the description below in relation to FIG. 7. As described below, the selection may include one or more services 315. The selection may also include one or more of peer devices 520(1)-520(N).

In step 605, PC 505 may communicate 525A with host 310. Communication 525A may include a command sent from PC 505 and received at host 310, the command including the contacts selected in step 602 and directing host 310 to share media with computing devices associated with the selected contacts. The media to share may be stored at PC 505 and the media (or a copy of the media) may be included in the command. Alternatively, the media may be stored at host 310, and responsive to the command, host 310 may distribute the media to one or more computing devices based at least in part on the selected contacts.

In some embodiments, the foregoing techniques may be combined in relation to where the media is stored. For example, the first time PC 505 wishes to distribute a particular video file, the video file might not be saved at host 310. As such, PC 505 may include the video file in a command to share the video file. Upon receipt of the command, host 310 may save the video file and may distribute (e.g., upload or transmit) the video file as described below in conjunction with steps 610 and 615 to the contacts selected in step 602. If a subsequent command to distribute the video file is received at host 310 from a computing device (e.g., PC 505 or another computing device not shown), the command might not need to include the video file because it is stored at host 310.

To support these combined techniques, the video file may include metadata that uniquely identifies the video file. PC 505 may initially presume that host 310 has a copy of the video file stored at host 310, and may include the identifying metadata in the command of step 605. Host 310 may compare the metadata included with the command against metadata associated with one or more video files stored at host 310. If a match is found, host 310 may distribute the video file associated with the matching metadata. If a match is not found, host 310 may request PC 505 to transmit the video file to host 310. Based on the foregoing description, PC 505 and host 310 may be able to leverage off of a prior transaction (not necessarily involving PC 505) that involved the saving of the video file at host 310. Accordingly, bandwidth may be conserved with respect to host 310, particularly in relation to large media types (e.g., lengthy video files).

In step 610, host 310 may communicate 525B with one or more services 315. Communication 525B may be responsive to the command received in conjunction with step 605 described above. Communication 525B may include a command to upload media to service 315 (or to multiple services, when multiple contacts are selected). The media may be uploaded to a specific channel or account identified by a contact entry associated with PC 505, which may be the same channel or account associated with the credential of step 405 described above. As used in this context, channel may encompass one or more people, buddies, albums and the like, each represented by a separate contact entry in a contact listing which a user (e.g., a user of PC 505) selects as the target or destination of an uploading or sharing operation. Once the media has been uploaded to service 315, users may subsequently obtain the media from service 315 via one or more operations (e.g., a download operation). For example, one or more of peer devices 520(1)-520(N) may communicate 525D with service 315 to obtain the media subsequent to the upload of the media to service 315.

In step 615, host 310 may communicate 525C with one or more of peer devices 520(1)-520(N). Communication 525C may be responsive to the command received at host 310 in conjunction with step 605 described above. Communication 525C may include a transmission of the media from host 310 to one or more of peer devices 520(1)-520(N).

Steps 610 and 625 (or more specifically, communications 525B and 525C) may execute concurrently, or that is to say, at substantially the same time as one another or in parallel such that it appears to (a user of) PC 505 that the steps are occurring at the same time, regardless of whether the steps are actually occurring at the same instant in time.

It is understood that in some embodiments, one or more steps of the methods described above and illustrated in FIGS. 4 and 6 may be optional. Additionally, steps not shown may be added without departing from the scope and spirit of the instant disclosure.

FIG. 7 illustrates a use case scenario suitable for demonstrating one or more aspects of the invention. Specifically, FIG. 7 illustrates a display screen 700 (which may be equivalent to display 236 of FIG. 2) displaying a list of contacts 705. In particular, the list of contacts includes Alberto Juarez 705a and Joseph Lyles 705b-c. Icons 710 may also be displayed to provide an indication of the nature of a particular contact 705. For example, as shown in FIG. 7, the contact entries corresponding to Alberto Juarez 705a and Joseph Lyles 705b may each illustrate a device (e.g., a personal computer) associated with each contact's home (as indicated by “home” icons 710a and 710b, respectively). Similarly, the contact entry corresponding to Joseph Lyles 705c may illustrate a mobile device (as indicated by “mobile device” icon 710c) belonging to one Joseph Lyles. Display screen 700 may also display contacts corresponding to one or more services. As shown in FIG. 7, display screen 700 includes a contact entry entitled My Media 705d, which may correspond to a commercial service, a user generated/provided service or the like. Associated with contact entry My Media 705d is a cyclone icon 710d. Icon 710d may be generated by the service referenced by contact entry 705d, or icon 710d may be a predetermined, user-created or user-selected icon.

FIG. 7 also includes a listing of status 715 with respect to a file 720 named “my_video.” For example, file 720 may have been shared with the contacts represented by 705a/710a and 705b/710b as demonstrated via status 725a and 725b, respectively. Similarly, file 720 may have been uploaded to the My Media service represented by contact information 705d/710d as demonstrated via status 725d. If file 720 is relatively large, a status of blocked 725c may be indicated for the mobile device represented by contact information 705c/710c. The status information provided in FIG. 7 is merely illustrative. Other status information may be used or included in the listing of status 715. Only a single media file (e.g., file 720) is shown in FIG. 7, however, it is understood that additional media may be referenced.

Display screen 700 may be touch-sensitive. As such, a user may be able to select a contact by touching (with one's finger, a probe, a stylus, or other such instrument) at least one of contact entries 705 and icons 710. Alternatively, one or more menus or directional buttons may facilitate selection of a contact. In some embodiments, the display screen illustrated in FIG. 7 may be modified to include a checkbox, differential shading, or the like to provide feedback to a user as to which contacts have been selected.

As illustrated in FIG. 7, display screen 700 may be configured to combine in one simple display view personal contacts 705a-c with one or more service contacts (e.g., contact 705d). The contents of display screen 700 may be modified or adapted without departing from the scope and spirit of the instant disclosure. For example, a user may have an option, via depression of an input key, switch, button, voice command, or the like, to toggle the display from personal contacts 705a-c on a first screen and service contact(s) 705d on a second screen.

Based on the foregoing description, it is understood that a user of a computing device (e.g., PC 305, 505) may provide a credential related to a (third-party) service (e.g., service 315). Responsive to an authentication of the credential (performed at either the service or a host (e.g., host 310)), an identification (e.g., a name, picture, logo, icon, or the like) of the service may be added to a phonebook or other such contact listing associated with the user's computing device. Thereafter, the user of the computing device may select the service from the contact listing to upload media to the service while directing that the media be transmitted to one or more peer devices (e.g., peer devices 520(1)-520(N)).

Based on the foregoing description, a user may select individual contacts and one or more services from a contact listing as targets/destinations for shared media via a single user interface window. As such, the selection process is streamlined relative to conventional techniques for the distribution of media because a user is not required to engage multiple and complicated settings windows to distribute media to a plurality of different computing entities with different configurations. Moreover, with respect to a client-server type of computer architecture (e.g., such as the architectures of FIGS. 3 and 5, wherein PC 305, 505 and peer devices 520(1)-520(N) may be analogized to client computer devices, and host 310 and service 315 may be analogized to server computer devices), the functionality may be implemented at the server computer devices, thereby avoiding complicated updates or recalls of client computer devices already out in the field.

The foregoing description was provided in relation to the sharing and distribution of media (e.g., pictures, audio, video files). In some embodiments, the contact list including information related to a service (e.g., service 315) might only be presented when a user of a computing device wishes to share media, and otherwise if the computing device is used for another purpose (e.g., to place a phone call or to send a short message service (SMS) message) a conventional contact listing may be presented to the user of the computing device without including the service(s) 315. It is understood, however, that the disclosure provided herein may be used to support the sharing and distribution of other types of content objects (e.g., text files) in addition to media, and that services may be included in a contact listing to support such activities. Moreover, as services are added as contacts to a contact listing or phonebook, the services may be accessed by other applications (e.g., social networking applications or other sharing applications).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving from a computing device at least one credential associated with a service;
validating the at least one credential;
transmitting a request to the service for shared service contact information based at least in part on the validated at least on credential;
receiving the shared service contact information from the service responsive to the transmitted request; and
transmitting service contact information to the computing device base at least in part on the received shared service contact information.
